(19) United States
(12) Patent Application Publication
(10) Pub. No.: US 2015/0050031 A1
(43) Pub. Date: Feb. 19, 2015

(54) Wireless Power Transmission Across a Rotating Interface

(71) Applicant: Princetel Inc., Hamilton, NJ (US)

(72) Inventors: Louis D. Violante, Monroe, NJ (US); Boying B. Zhang, Lawrenceville, NJ (US); Hong Zhang, News Brunswick, NJ (US)

(73) Assignee: Princetel Inc., Hamilton, NJ (US)

(21) Appl. No.: 13/967,378

(22) Filed: Aug. 15, 2013

(51) Int. Cl. H04B 10/80; H04B 10/25; H02J 17/00

(52) U.S. Cl. CPC H04B 10/80; H02J 17/00; H04B 10/2504
USPC 398/200

(57) ABSTRACT

A method for enabling the transmission of power between two mutually rotating members without the use of wires or heavy inductive bundles has been invented in which the electrical signal is first converted an electro-magnetic wave, such as an optical or infrared beam, then transmit across the rotational interface using a fiber optic rotation joint, or similar device, and then finally converting that beam back into electrical power.

This application claims benefit to provisional application No. 61/684,361, filed on Aug. 17, 2012, which is incorporated by reference herein in its entirety.

### BACKGROUND OF INVENTION

Electrical rotary joints, or electrical slip rings, are electromechanical devices that consist of rotational (rotors) and stationary (stators) members. They allow the transmission of electrical signals and power from their rotors to stators or vise verse.

A conventional electrical slip ring consists of conductive rings mounted on a rotor and insulated from it. Fixed brushes run in contact with the rings, rubbing against the peripheral surfaces of the rings, transferring electrical power to the stator. The sliding contact between the rings and brushes during this continuous rotation of the rotor causes the wear on the slip rings and generate heat, even noise in the system.

There are also so called brushless slip rings that use inductive coils to create a magnetic field in one end of the slip ring then uses a matching inductive coil to turn that magnetic field back into an electric signal or power. However, these devices are relatively heavy due to the large amount of metal required for the inductive coils.

Often times an electrical slip ring is paired with a fiber optic rotary joint created a hybrid rotary joint, where a data and/or video signal is sent through the fiber optic rotary joint and the power is sent through the electrical slip ring. These hybrid units are often an assembly composed of a fiber optic rotary joint and an electrical slip ring manufactured separately then mounted together either in a single larger enclosure or with one nested within the other. Either way the net result is an oversized device that weighs much more then it needed.

However, continued advances in wireless power transmission are making laser power beaming an increasingly efficient way of transmitting power. This method of power transmission uses high intensity lasers to generate a light beam which is then focused on photovoltaic cells which converts that light beam into electrical power in much the same way that a solar panel converts the sunlight into electrical power. Using this method of power transmission the power can be transmitted through the fiber optic rotary joint with the data/video signals, thereby eliminating the need for the electrical slip ring and greatly reducing both the total size and weight of the device needed to transmit both the data signal and the power.

### BRIEF DESCRIPTION OF THE DRAWINGS

FIG. 1—A representative depiction of the basic optical components of a multichannel rotary joint

FIG. 2—A representative depiction of the optical and electro-optical components contained within one possible embodiment of the invention described herein

FIG. 3—A representative description of a second possible embodiment of the invention described herein

FIG. 4—A representative description of a third possible embodiment of the invention described herein

FIG. 5—A representative description of a fourth possible embodiment of the invention described herein

FIG. 6—A representative description of a fifth possible embodiment of the invention described herein

### DESCRIPTION OF THE INVENTION

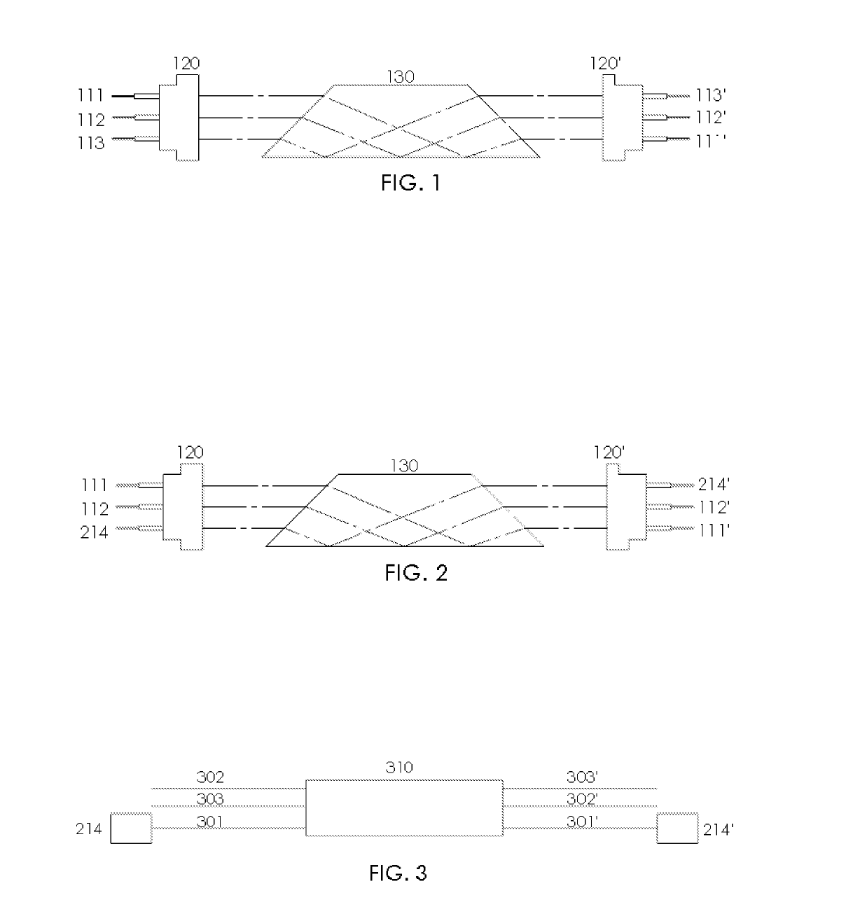

A typical multi-channel fiber optic rotary joint consist of three basic parts: a stator side collimator array, a rotor side collimator array and a de-rotating mechanism. As shown in FIG. 1, the signals originates from the stator side collimators (111, 112, 113) in the stator side collimator array (120) then pass through the de-rotating mechanism (130) and are re-captured in by the rotor side collimators (111′, 112′, 113′) in the rotor side collimator array (120′). Note that since these types of fiber optic rotary joints are bi-directional the signal can originate in either the rotor or stator side and be recaptured by either the rotor or stator side; however, for illustrative purposes only we shall assume, without the loss of generality, the signal originates on the stator side. In addition, the figures show the de-rotating mechanism as a dove prism; however, this is also for illustrative purposes only. The device will work with any number reflective prisms and/or mirror which are arranged to achieve a similar output as the reflective prisms.

By replacing one of the stator side collimators (111, 112 or 113) in FIG. 1 with a collimated laser power beaming source (214) as in FIG. 2 and the replacing the corresponding rotor side collimator (111′, 112′ or 113′) in FIG. 1 with a photovoltaic cell (214′) as in FIG. 2 then the resulting device can transmit two channels of data and one channel of power across a rotary interface. This overall package will be significantly small and lighter than a two channel fiber optic rotary joint with a one channel slip ring.

Both of the configurations illustrated in FIGS. 1 and 2 would typically have gearing structure around the de-rotating mechanism to aid in the de-rotation. This structure would typically have a 2:1 ratio so the de-rotating mechanism would rotate at ½ the speed as the rotor or the stator collimator holds.

The configuration in FIG. 2 could also be slightly modified by moving the laser power beaming source (214) outside the fiber optic rotary joint (310) as should in FIG. 3 and have the an optical fiber (301) laser power beam into the fiber optic rotary joint (310) where it is passed across the rotating interface in the same or in a similar manner as the data signals each being carried by an optical fiber (302 and 303). Then upon exiting the fiber optic rotary joint (310) the two data signals are each carried by an optical fibers (302′ and 303′) and the laser power beam is carried by an optical fiber (301′) to a photovoltaic cell (214′) where it is converted back to electrical power.

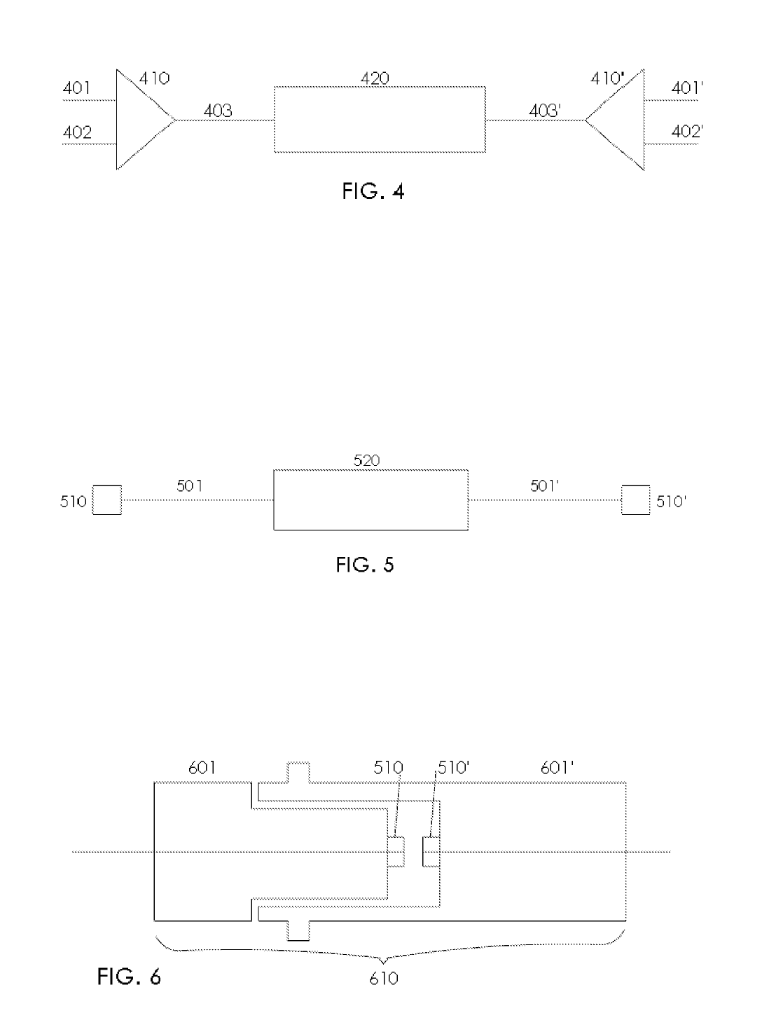

Another possible configuration that would maximize weight, space and cost savings is to multiplex the data signals with the laser power beam. In this configuration, shown in FIG. 4, one stream of data being carried by an optical fiber (401) and a laser power beam being carried by a second optical fiber (402) are combined, or multiplexed, into a single laser power beam/data signal by a multiplexer (410) and are the transmitted by an optical fiber (403) to a fiber optic rotary joint (420) where they are passed across the rotating interface. Upon exiting the fiber optic rotary joint (420) the combined laser power beam/data signal is carried by another optical fiber (403′) to another multiplexer (410′) where the combined laser power beam/data signal is de-multiplexed, or separated, into a separate data signal (401′) and a single laser power beam (402′).

A fourth possible configuration, as shown in FIG. 5, is to have an optical fiber (501) carry a laser power beam, which originated from a laser power beaming source (510), to a fiber optic rotary joint (520) where it is passed across the rotating interface. Upon exiting the fiber optic rotatory joint (520) the laser power beam is carried by another optical fiber (501′) to a photovoltaic cell (510′) where is it converted back into electric power.

A fifth possible configuration, as shown in FIG. 6, is to move the laser power beaming source (510) to either the rotor (601) or stator (601′) side within the fiber optic rotary joint (610), for illustrative purposes only FIG. 6 shows the power beaming source (510) on the rotor (601) side, and move the photovoltaic cell (510′) to the rotor (601) or stator (601′) within the fiber optic rotary joint (610) on the other side of the rotating interface (620) opposite the laser power beaming source (510), for illustrative purposes only FIG. 6 shows the photovoltaic cell (510′) on the stator (601′) side, where is it converted back into an electrical power signal.

It should be noted that in all of the aforementioned configurations the photovoltaic cells and/or the laser power beaming sources may be replaced by an array or photovoltaic cells and/or array of laser power beaming sources without significantly changing any aspect of the overall device and/or process reference herein.

1. (canceled)

2. (canceled)

3. (canceled)

4. (canceled)

5. (canceled)

6. A multichannel fiber optic rotary joint for simultaneous data signal and power beam transmission comprising:
a first collimator holder having a first collimator array and a laser power beaming source;
a second collimator holder having a second collimator array and a photovoltaic cell;
an optic de-rotating element;
a rotor side housing and a stator side house with a common rotary axis;
a plurality of bearings;
a plurality of gears;
wherein said first collimator holder is within a rotor side house and aligned with said second collimator holder which is within the stator side housing, said laser power beaming source within said first collimator holder aligned with said photovoltaic cell within said second collimator holder; and
said optic de-rotating element, positioned between said first collimator holder and said second collimator holder, arranged for rotation about said rotary axes relative to said rotor side housing and said stator side housing at a rotary speed equal to one-half the relative rotational rate between said rotor side housing and said stator side housing.

7. A method for simultaneous transmission of a data signal and power beam across a rotating interface comprising:
a multi channel rotary joint having a plurality of optical fiber, a laser power beaming source, a photovoltaic cell, and a plurality of optical transmitters and optical receivers to carry out the steps:
a. launching a plurality of power beams by said laser power beaming sources into a plurality of optical fibers to said multichannel rotary joint;
b. launching a plurality of data signals by said optical transmitters into a plurality of optical fibers to said multichannel rotary joint;
c. transmitting through said multichannel rotary joint said data signals and said power beams across the rotational interface into a plurality of optical fibers; and
d. launching said data signals into said optical fibers with said optical detectors and launching said power beams into said optical fibers with the photovoltaic cells.

8. A method for simultaneous transmission of a data signal and power beam across a rotating interface comprising:
a single channel rotary joint having a plurality of multiplexers, a plurality of optical fiber, a laser power beaming source, a photovoltaic cell, and a plurality of optical transmitters and optical receivers to carry out the step:
a. launching a power beam by said laser power beaming source into an optical fiber;
b. launching a data signal by said optical transmitters into a second optical fiber;
c. said multiplexers receiving the power beam and the data signal from said optical fibers then multiplexing them into a single multiplexed beam;
d. launching said multiplexed beam down a third optical fiber to said single channel rotary joint and transmitting across the rotational interface;
e. a second multiplexer receiving the multiplexed beam from a fourth optical fiber, separating said power beam and said data signal by the second multiplexer into a fifth and sixth optical fiber; and
f. launching said data signal into the optical fiber with said optical detector and said power beam into the optical fiber with the photovoltaic cell.

9. A method for transmitting a power beam across a rotating interface comprising:
a single channel rotary joint having a plurality of optical fibers, a laser power beaming source, a photovoltaic cell, a plurality of optical transmitters and optical receivers to carry out the steps:
a. launching a power beam by said laser power beaming source into an optical fiber to said single channel rotary joint;
b. transmitting the power beam across the rotational interface; and
c. launching said power beam into a second optical fiber with the photovoltaic cell.

10. A method for transmitting a power beam across a rotating interface comprising:
a rotor and a stator with a common rotary axis having a plurality of bearings, a laser power beaming source, a photovoltaic cell, and a plurality of wire, wherein said laser power beaming source is mechanically attached to said rotor and said photovoltaic cell is mechanically attached to said stator to carry out the steps:
a. ensuring the relatively rotatable of said rotor and said stator aligned;
b. impinging the power beam emitted from said laser power beaming source upon said photovoltaic cell; and
c. transmitting the power by said wire to the laser power beaming source, as well as, transmitting the power from the photovoltaic cell.
